(19) United States
(12) Patent Application Publication
(10) Pub. No.: US 2014/0349000 A1
(43) Pub. Date: Nov. 27, 2014

(54) THERMALLY PROCESSED SHELF-STABLE DAIRY-BASED COMPOSITION AND METHODS FOR MAKING SAME

(71) Applicant: NESTEC S.A., Vevey (CH)

(72) Inventors: Elizabeth Ann-Clubbs Koenig, Rockford, MI (US); Eric Edward Graf, Holton, MI (US)

(21) Appl. No.: 14/363,799

(22) PCT Filed: Jan. 3, 2013
(86) PCT No.: PCT/IB2013/050064

§ 371 Date: Jun. 8, 2014

(30) Foreign Application Priority Data
Jan. 3, 2012 (US) 61582617
Sep. 27, 2012 (US) 61706284

(51) Int. Cl. A23C 3/023; A23C 9/13; A23C 9/133

(52) U.S. Cl. CPC A23C 3/023; A23C 9/133; A23C 9/1315
USPC 426/522

(57) ABSTRACT

The present disclosure provides dairy compositions comprising particulates and having good color, flavor, and texture after thermal processing. In a general embodiment, the compositions include particulates such as fruits and/or grains, and the compositions are thermally processed and shelf-stable. Methods for reducing or inhibiting browning of dairy-based compositions are also provided. The methods include, for example, thermally processing a dairy composition including particulates such as fruits and/or grains at a temperature that is less than about 240° F. The compositions and methods of the present disclosure provide several advantages including, for example, the reduction or avoidance of degradation/browning of the compositions during processing and storage.

### BACKGROUND

The present disclosure relates generally to foods and food processing. More specifically, the present disclosure relates to dairy compositions comprising particulates and having good color and flavor after thermal processing. Methods for making same are also provided.

Retort processing of dairy-based compositions are steam-based processes used to sterilize compositions in a sealed container. There are generally four steam-based processes that are used in sterilizing food, nutraceutical, and pharmaceutical compositions. Steam can be the direct heating media (e.g., saturated steam) or the indirect heating media (e.g., steam-heated water used in a water immersion process). The different types of retort processes include the following: (i) saturated steam (direct steam heating); (ii) water immersion, both rotary and static (indirect steam heating); (iii) water spray, both rotary and static (indirect steam heating); and (iv) steam-air, both rotary and static (direct steam heating).

Aseptic processing of dairy-based compositions has been used since about the 1960's to sterilize compositions and to package the sterilized compositions in sterile containers. Aseptic food preservation methods allow processed foods to keep for long periods of time without preservatives, as long as they are not opened and exposed to the atmosphere. However, the use of aseptic processing techniques is limited because the techniques are relatively expensive, not available to all markets, approved by the Food and Drug Administration (“FDA”) for use only with homogeneous food matrices, and involve very high heating temperatures.

Unfortunately, dairy-based foods (e.g., yogurts) are highly susceptible to color and flavor changes during thermal processing such as aseptic and retort processing. Although most yogurts are refrigerated products that are not subjected to the high temperatures that occur during aseptic and retort processing, aseptic and retort processing of yogurts can cause undesired color and flavor changes. Providing a yogurt having particulates therein creates yet another dilemma with respect to aseptic and retort processing of yogurts since a yogurt containing particulates is not a homogeneous product for which use of aseptic and retort processes are approved.

### SUMMARY

Methods of making retorted, shelf-stable dairy-based compositions are provided. Methods for reducing brownness in a retorted, shelf-stable dairy-based composition are also provided. In a general embodiment, methods for reducing browning of a retorted, shelf-stable dairy-based composition are provided. The methods include providing a dairy-based composition including milk protein concentrate and a reduced amount of reducing sugars, and thermally processing the dairy-based composition.

In another embodiment, methods for making a retorted, shelf-stable dairy-based composition are provided. The methods include providing a dairy-based composition including milk protein concentrate and a reduced amount of reducing sugars, and thermally processing the dairy-based composition to make the retorted, shelf-stable dairy-based composition.

In an embodiment, the reducing sugars are selected from the group consisting of glucose, fructose, lactose, or combinations thereof.

In an embodiment, the dairy-based composition is substantially free of reducing sugars. The dairy-based composition may include only a naturally occurring amount of reducing sugars. In an embodiment, the dairy-based composition including only a naturally occurring amount of lactose.

In an embodiment, the dairy-based composition is a yogurt-like product.

In an embodiment, the dairy-based composition includes particulates. The particulates may be selected from the group consisting of fruit, fruit pieces, grains, nuts, or combinations thereof.

In an embodiment, the thermal process is a retorting process.

In yet another embodiment, methods for reducing browning of a retorted, shelf-stable dairy-based composition are provided. The methods include providing a dairy-based composition, and thermally processing the dairy-based composition at a temperature that is less than about 240° F.

In still yet another embodiment, methods for making a retorted, shelf-stable dairy-based composition are provided. The methods include providing dairy-based compositions, and thermally processing the dairy-based composition at a temperature that is less than about 240° F. to make the retorted, shelf-stable dairy-based composition.

In an embodiment, the dairy-based composition includes particulates. The particulates may be selected from the group consisting of fruit, fruit pieces, nuts, grains, or combinations thereof.

In an embodiment, the thermal processing occurs at a temperature from about 190° F. to about 240° F., or from about 200° F. to about 230° F., or from about 210° F. to about 220° F.

In an embodiment, the thermal processing occurs at a temperature from about 190° F. to about 210° F. and for an amount of time from about 15 to about 40 minutes. Alternatively, the thermal processing occurs at a temperature of about 200° F. and for an amount of time from about 20 to about 25 minutes. The thermal processing may also occur at a temperature from about 200° F. to about 220° F. and for an amount of time from about 10 to about 25 minutes, or at a temperature of about 210° F. and for an amount of time from about 15 to about 20 minutes, or at a temperature from about 210° F. to about 230° F. and for an amount of time from about 5 to about 20 minutes. In an embodiment, the thermal processing occurs at a temperature of about 220° F. and for an amount of time from about 10 to about 15 minutes.

In an embodiment, the thermal process is a retorting process.

In an embodiment, the dairy-based composition is a yogurt composition.

In an embodiment, the dairy-based composition includes at least one ingredient selected from the group consisting of a low fat yogurt, pectin, sugar, starch, or combinations thereof.

In an embodiment, the dairy-based composition has a pH at or below about 4.2.

In another embodiment, methods for reducing browning of an retorted, shelf-stable dairy-based composition are provided. The methods include providing a dairy-based composition including milk protein concentrate and a reduced amount of reducing sugars, and thermally processing the dairy-based composition at a temperature that is less than about 240° F.

In yet another embodiment, methods for making a retorted, shelf-stable dairy-based composition are provided. The methods include providing a dairy-based composition including milk protein concentrate and a reduced amount of reducing sugars, and thermally processing the dairy-based composition at a temperature that is less than about 240° F. to make the retorted, shelf-stable dairy-based composition.

In an embodiment, the reducing sugars are selected from the group consisting of glucose, fructose, lactose, or combinations thereof.

In an embodiment, the dairy-based composition is substantially free of reducing sugars.

In an embodiment, the dairy-based composition includes only a naturally occurring amount of reducing sugars. In an embodiment, the dairy-based composition includes only a naturally occurring amount of lactose.

In an embodiment, the dairy-based composition includes particulates. The particulates may be selected from the group consisting of fruit, fruit pieces, nuts, grains, or combinations thereof.

In an embodiment, the thermal processing occurs at a temperature from about 190° F. to about 210° F. and for an amount of time from about 15 to about 40 minutes. Alternatively, the thermal processing occurs at a temperature of about 200° F. and for an amount of time from about 20 to about 25 minutes. The thermal processing may also occur at a temperature from about 200° F. to about 220° F. and for an amount of time from about 10 to about 25 minutes, or at a temperature of about 210° F. and for an amount of time from about 15 to about 20 minutes, or at a temperature from about 210° F. to about 230° F. and for an amount of time from about 5 to about 20 minutes. In an embodiment, the thermal processing occurs at a temperature of about 220° F. and for an amount of time from about 10 to about 15 minutes. In an embodiment, the thermal process is a retorting process.

In an embodiment, the dairy-based composition is a yogurt composition.

In an embodiment, the dairy-based composition includes at least one ingredient selected from the group consisting of a low fat yogurt, pectin, sugar, starch, or combinations thereof.

In an embodiment, the dairy-based composition has a pH at or below about 4.2.

In still yet another embodiment, methods for improving particle integrity of a retorted, shelf-stable dairy-based composition are provided. The methods include providing a dairy-based composition including particulates selected from the group consisting of fruit, fruit pieces, grains, nuts, or combinations thereof, and thermally processing the dairy-based composition at a temperature that is less than about 240° F.

In yet another embodiment, methods for making a retorted, shelf-stable dairy-based composition having particulates are provided. The methods include providing a dairy-based composition including particulates selected from the group consisting of fruit, fruit pieces, grains, nuts, or combinations thereof, and thermally processing the dairy-based composition at a temperature that is less than about 240° F.

In an embodiment, the grains are selected from the group consisting of amaranth, barley, buckwheat, corn, cornmeal, popcorn, millet, oats, oatmeal, quinoa, rice, rye, sorghum, teff, triticale, wheat, wild rice, or combinations thereof. In an embodiment, the grains are oats and barley.

In an embodiment, the fruit is selected from the group consisting of apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, or combinations thereof.

In an embodiment, the thermal processing occurs at a temperature from about 190° F. to about 210° F. and for an amount of time from about 15 to about 40 minutes. Alternatively, the thermal processing occurs at a temperature of about 200° F. and for an amount of time from about 20 to about 25 minutes. The thermal processing may also occur at a temperature from about 200° F. to about 220° F. and for an amount of time from about 10 to about 25 minutes, or at a temperature of about 210° F. and for an amount of time from about 15 to about 20 minutes, or at a temperature from about 210° F. to about 230° F. and for an amount of time from about 5 to about 20 minutes. In an embodiment, the thermal processing occurs at a temperature of about 220° F. and for an amount of time from about 10 to about 15 minutes.

In an embodiment, the thermal process is a retorting process.

In an embodiment, the dairy-based composition is a yogurt composition.

In an embodiment, the dairy-based composition includes at least one ingredient selected from the group consisting of a low fat yogurt, pectin, sugar, starch, or combinations thereof.

An advantage of the present disclosure is to provide improved dairy-based compositions.

Another advantage of the present disclosure is to provide retorted, shelf-stable yogurt products having particulates and good coloring after thermal processing.

Yet another advantage of the present disclosure is to provide methods for reducing or inhibiting browning of dairy-based compositions during storage and shelf-life.

Still yet another advantage of the present disclosure is to provide dairy-based compositions that are less susceptible to Maillard reactions.

Another advantage of the present disclosure is to provide improved retorted processing methods for dairy-based compositions.

Yet another advantage of the present disclosure is to increase consumer appeal for retorted, shelf-stable yogurt products.

Still yet another advantage of the present disclosure is to provide methods for improving the integrity of particles in a dairy-based composition.

Additional features and advantages are described herein, and will be apparent from the following Detailed Description.

### DETAILED DESCRIPTION

As used herein, the singular forms “a,” “an” and “the” include plural referents unless the context clearly dictates otherwise. Thus, for example, reference to “a polypeptide” includes a mixture of two or more polypeptides and the like.

As used herein, “about” is understood to refer to numbers in a range of numerals. Moreover, all numerical ranges herein should be understood to include all integer, whole or fractions, within the range.

As used herein, “aseptic” is understood to include thermally processed.

As used herein, “thermally processed” is understood to include retorted and aseptic.

As used herein, “retorted” is understood to include thermally processed.

As used herein, the phrase “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, “animal” includes, but is not limited to, mammals, which include but is not limited to, rodents, aquatic mammals, domestic animals such as dogs and cats, farm animals such as sheep, pigs, cows and horses, and humans. Wherein the terms “animal” or “mammal” or their plurals are used, it is contemplated that it also applies to any animals that are capable of the effect exhibited or intended to be exhibited by the context of the passage.

As used herein, the term “antioxidant” is understood to include any one or more of various substances such as beta-carotene (a vitamin A precursor), vitamin C, vitamin E, and selenium that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin B₁, vitamin B₆, vitamin B₁₂, vitamin C, vitamin D, vitamin E, zeaxanthin, or combinations thereof.

As used herein, “carbohydrate(s)” are meant to include Monosaccharides include Trioses (such as: Ketotriose (Dihydroxyacetone); Aldotriose (Glyceraldehyde)); Tetroses which include: Ketotetrose (such as: Erythrulose) and Aldotetroses (such as:Erythrose, Threose); Pentoses which include: Ketopentose (such as:Ribulose, Xylulose) Aldopentose (such as:Ribose, Arabinose, Xylose, Lyxose), Deoxy sugar (such as: Deoxyribose); Hexoses which include: Ketohexose (such as:Psicose, Fructose, Sorbose, Tagatose), Aldohexose (such as: Allose, Altrose, Glucose, Mannose, Gulose, Idose, Galactose, Talose), Deoxy sugar (such as: Fucose, Fuculose, Rhamnose); Heptose (such as: Sedoheptulose); Octose; Nonose (such as: Neuraminic acid); Disaccharides which include: Sucrose; Lactose; Maltose; Trehalose; Turanose; Cellobiose; kojiboise; nigerose; isomaltose; and palatinose; Trisaccharides which include: Melezitose; and Maltotriose; Oligosaccharides which include: corn syrups and maltodextrin; and Polysaccharides which include: glucan (such as dextrin, dextran, beta-glucan), glycogen, mannan, galactan, and starch (such as those from corn, wheat, tapioca, rice, and potato, including Amylose and Amylopectin. The starches can be natural or modified or gelatinized); and combinations thereof. Carbohydrates also include source of sweeteners such as honey, maple syrup, glucose (dextrose), corn syrup, corn syrup solids, high fructose corn syrups, crystalline fructose, juice concentrates, and crystalline juice.

As used herein, “food grade micro-organisms” means micro-organisms that are used and generally regarded as safe for use in food.

While the terms “individual” and “patient” are often used herein to refer to a human, the invention is not so limited. Accordingly, the terms “individual” and “patient” refer to any animal, mammal or human having or at risk for a medical condition that can benefit from the treatment.

As used herein, non-limiting examples of sources of ω-3 fatty acids such α-linolenic acid (“ALA”), docosahexaenoic acid (“DHA”) and eicosapentaenoic acid (“EPA”) include fish oil, krill, poultry, eggs, or other plant or nut sources such as flax seed, walnuts, almonds, algae, modified plants, etc.

As used herein, “mammal” includes, but is not limited to, rodents, aquatic mammals, domestic animals such as dogs and cats, farm animals such as sheep, pigs, cows and horses, and humans. Wherein the term “mammal” is used, it is contemplated that it also applies to other animals that are capable of the effect exhibited or intended to be exhibited by the mammal.

The term “microorganism” is meant to include the bacterium, yeast and/or fungi, a cell growth medium with the microorganism, or a cell growth medium in which microorganism was cultivated.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

As used herein, a “non-replicating” microorganism means that no viable cells and/or colony forming units can be detected by classical plating methods. Such classical plating methods are summarized in the microbiology book: James Monroe Jay, et al., Modern food microbiology, 7th edition, Springer Science, New York, N.Y. p. 790 (2005). Typically, the absence of viable cells can be shown as follows: no visible colony on agar plates or no increasing turbidity in liquid growth medium after inoculation with different concentrations of bacterial preparations (‘non replicating’ samples) and incubation under appropriate conditions (aerobic and/or anaerobic atmosphere for at least 24 h). For example, bifidobacteria such as Bifidobacterium longum, Bifidobacterium lactis and Bifidobacterium breve or lactobacilli, such as Lactobacillus paracasei or Lactobacillus rhamnosus, may be rendered non-replicating by heat treatment, in particular low temperature/long time heat treatment.

As used herein, a “nucleotide” is understood to be a subunit of deoxyribonucleic acid (“DNA”) or ribonucleic acid (“RNA”). It is an organic compound made up of a nitrogenous base, a phosphate molecule, and a sugar molecule (deoxyribose in DNA and ribose in RNA). Individual nucleotide monomers (single units) are linked together to form polymers, or long chains. Exogenous nucleotides are specifically provided by dietary supplementation. The exogenous nucleotide can be in a monomeric form such as, for example, 5′-Adenosine Monophosphate (“5′-AMP”), 5′-Guanosine Monophosphate (“5′-GMP”), 5′-Cytosine Monophosphate (“5′-CMP”), 5′-Uracil Monophosphate (“5′-UMP”), 5′-Inosine Monophosphate (“5′-IMP”), 5′-Thymine Monophosphate (“5′-TMP”), or combinations thereof. The exogenous nucleotide can also be in a polymeric form such as, for example, an intact RNA. There can be multiple sources of the polymeric form such as, for example, yeast RNA.

“Nutritional compositions,” or “nutritional products,” as used herein, are understood to include any number of wholesome food ingredients and possibly optional additional ingredients based on a functional need in the product and in full compliance with all applicable regulations. The optional ingredients may include, but are not limited to, conventional food additives, for example one or more, acidulants, additional thickeners, buffers or agents for pH adjustment, chelating agents, colorants, emulsifies, excipient, flavor agent, mineral, osmotic agents, a pharmaceutically acceptable carrier, preservatives, stabilizers, sugar, sweeteners, texturizers, and/or vitamins. The optional ingredients can be added in any suitable amount.

As used herein the term “patient” is understood to include an animal, especially a mammal, and more especially a human that is receiving or intended to receive treatment, as it is herein defined.

As used herein, “phytochemicals” or “phytonutrients” are non-nutritive compounds that are found in many foods. Phytochemicals are functional foods that have health benefits beyond basic nutrition, and are health promoting compounds that come from plant sources. “Phytochemicals” and “Phytonutrients” refers to any chemical produced by a plant that imparts one or more health benefit on the user. Non-limiting examples of phytochemicals and phytonutrients include those that are:

i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins;

ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta sitosterol, gamma sitosterol, stigmasterol), tocopherols (vitamin E), and ω-3, -6, and -9 fatty acids (such as, for example, gamma-linolenic acid); triterpenoid (such as, for example, oleanolic acid, ursolic acid, betulinic acid, moronic acid);

iii) betalains which include Betacyanins (such as: betanin, isobetanin, probetanin, neobetanin); and betaxanthins (non glycosidic versions) (such as, for example, indicaxanthin, and vulgaxanthin);

iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide;

v) protein inhibitors, which include, for example, protease inhibitors;

vi) other organic acids which include oxalic acid, phytic acid (inositol hexaphosphate); tartaric acid; and anacardic acid; or

vii) combinations thereof.

As used herein, a “prebiotic” is a food substance that selectively promotes the growth of beneficial bacteria or inhibits the growth or mucosal adhesion of pathogenic bacteria in the intestines. They are not inactivated in the stomach and/or upper intestine or absorbed in the gastrointestinal tract of the person ingesting them, but they are fermented by the gastrointestinal microflora and/or by probiotics. Prebiotics are, for example, defined by Glenn R. Gibson and Marcel B. Roberfroid, “Dietary Modulation of the Human Colonic Microbiota: Introducing the Concept of Prebiotics,” J. Nutr. 1995 125: 1401-1412. Non-limiting examples of prebiotics include acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof.

As used herein, probiotic micro-organisms (hereinafter “probiotics”) are food-grade microorganisms (alive, including semi-viable or weakened, and/or non-replicating), metabolites, microbial cell preparations or components of microbial cells that could confer health benefits on the host when administered in adequate amounts, more specifically, that beneficially affect a host by improving its intestinal microbial balance, leading to effects on the health or well-being of the host. See, Salminen S, Ouwehand A. Benno Y. et al., “Probiotics: how should they be defined?,” Trends Food Sci. Technol., 1999:10, 107-10. In general, it is believed that these micro-organisms inhibit or influence the growth and/or metabolism of pathogenic bacteria in the intestinal tract. The probiotics may also activate the immune function of the host. For this reason, there have been many different approaches to include probiotics into food products. Non-limiting examples of probiotics include Aerococcus, Aspergillus, Bacillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present invention include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins include, for example, casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, green pea powder, green bean powder, and any proteins derived from beans, lentils, and pulses. Animal based proteins may be selected from the group consisting of beef, poultry, fish, lamb, seafood, or combinations thereof.

As used herein, a “symbiotic” is a supplement that contains both a prebiotic and a probiotic that work together to improve the microflora of the intestine.

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, folic acid and biotin) essential in minute amounts for normal growth and activity of the body and obtained naturally from plant and animal foods or synthetically made, pro-vitamins, derivatives, analogs.

In an embodiment, a source of vitamins or minerals can include at least two sources or forms of a particular nutrient. This represents a mixture of vitamin and mineral sources as found in a mixed diet. Also, a mixture may also be protective in case an individual has difficulty absorbing a specific form, a mixture may increase uptake through use of different transporters (e.g., zinc, selenium), or may offer a specific health benefit. As an example, there are several forms of vitamin E, with the most commonly consumed and researched being tocopherols (alpha, beta, gamma, delta) and, less commonly, tocotrienols (alpha, beta, gamma, delta), which all vary in biological activity. There is a structural difference such that the tocotrienols can more freely move around the cell membrane; several studies report various health benefits related to cholesterol levels, immune health, and reduced risk of cancer development. A mixture of tocopherols and tocotrienols would cover the range of biological activity.

Dairy-based foods such as, for example, yogurt are highly susceptible to color and flavor changes during thermal processing. However, since most yogurts sold are refrigerated and not subjected to a severe thermal process, color and/or flavor changes are not particularly problematic. These products are dependent on refrigeration, however, and have a very short shelf-life. To increase the shelf-life of various yogurt products, the yogurt products may be aseptically processed. Aseptic processing is the process by which a sterile (aseptic) product is packaged in a sterile container in a way that maintains sterility. Aseptic food preservation methods allow processed foods to keep for long periods of time without preservatives, as long as they are not opened and exposed to the atmosphere.

Currently, it is known to aseptically process yogurt to yield a shelf-stable product with desired colors and textures. However, not all markets have access to such an aseptic process and these types of processes are approved by the FDA only for homogenous food matrices. Indeed, Applicant believes that there does not currently exist a process to achieve a shelf-stable, aseptically processed dairy-based composition having particulates therein.

The particulates of the dairy-based compositions may include, but are not limited to, fruits, fruit pieces, grains, nuts, etc. Grains may include, for example, amaranth, barley, buckwheat, corn, cornmeal, popcorn, millet, oats, oatmeal, quinoa, rice, rye, sorghum, teff, triticale, wheat, wild rice, or combinations thereof. In an embodiment, the particulates are grains and include oats and barley. The particulates may also be fruit, which can include, for example, apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, or combinations thereof. The particulates can also include nuts, which may include, for example, almond, beech, butternut, brazilnut, candlenut, cashew, chestnut, colocynth, hickory, kola, macadamia, mamoncillo, maya, oak acorns, ogbono, paradise, pili, pistachio, walnut, or combinations thereof. The skilled artisan will appreciate that the particulates of the present dairy-based compositions are not limited to the particulates described herein.

The present disclosure provides for methods for retorting a yogurt that contains particulates without the undesirable affects of color and flavor changes that can occur after retorting. A first approach was formula-based. In the first approach, Applicant hypothesized that Maillard browning was contributing to the undesirable colors and/or flavors associated with the yogurt. Indeed, compositions including reducing sugars (e.g., glucose or fructose monomers, lactose, etc.) are at risk of decomposition during processing and shelf-life. This reaction is known as a “Maillard reaction” or “non-enzymatic browning.” In addition to the development of a dark color, such reactions can also result in the loss of the active compounds in the composition.

The main factors influencing Maillard Reactions are known (e.g., presence of amino groups, reducing sugars, pH, water content, temperature, etc.), and several actions may be taken to help reduce browning. Such actions include the following: (i) removing reducing sugars, which can be difficult in a food matrix containing cereals (e.g., with various available carbohydrates) or milk proteins ingredients (e.g., the presence of lactose); (ii) reducing the pH, which is difficult in a solid food matrix; (iii) decreasing storage temperature, which is not possible for shelf-stable products; and (iv) reducing water activity, which cannot be decreased too much without the product hardening substantially.

The formula of the first approach was then designed to reduce the amount of substances that contribute to Maillard browning. Many rounds of formulas were developed that contained very little lactose since as lactose is one particular type of reducing sugar that contributes to Maillard browning. One manner in which to reduce the amounts of lactose in the formula was to use Milk Protein Concentrate (“MPC”) instead of milk. Unfortunately, using MPC in place of milk results in a yogurt-like product that cannot actually be called yogurt. Experiments with various MPC-containing formulas demonstrated a reduction in color change, but not an elimination of color change. Thus, Applicant was able to find a way to reduce color change in a dairy-based food product.

A second approach by Applicant to mitigate color and/or flavor change of the yogurt during the retort process involved modification of the retort process itself. The foundation of thermal process is to achieve commercial sterility with heat and time. The higher the temperature of the process, the shorter the cook time that is needed to achieve commercial sterility, while the lower the temperature of the thermal process, the longer the cook time needed to achieve commercial sterility. Generally speaking, the shorter the process, the better the quality of the product. Acidic or acidified foods allow for a shorter thermal process than non-acidified foods. Indeed, yogurt is an acidic food and can, therefore, be processed for a shorter period of time. Under normal processing conditions, the process would be assigned at 240° F.-250° F. minutes to achieve commercial sterility in the shortest time possible.

However, Applicant has surprisingly found that the lower the temperature, regardless of the time, the less color change was demonstrated for yogurts after thermal processing. More specifically, Applicant surprisingly found that the lower the temperature, longer processing time resulted in a higher quality yogurt product. The assigned thermal process then changed from 250° F. to 200° F. To obtain such results, Applicant performed testing on the same yogurt composition consisting of low fat yogurt, pectin, sugar, and starch at different retorting times (e.g., 10, 15, 20 and 25 minutes) and temperatures (e.g., 200° F., 210° F. and 220° F.). For example, thermal processing of the present disclosure may occur at a temperature from about 190° F. to about 240° F., or from about 200° F. to about 230° F., or from about 210° F. to about 220° F. Additionally, thermal processing of the present disclosure may occur for an amount of time ranging from about 5 minutes to about 40 minutes, or from about 10 minutes to about 25 minutes, or from about 15 minutes to about 20 minutes.

In an embodiment, the thermal processing occurs at a temperature from about 190° F. to about 210° F. and for an amount of time from about 15 to about 40 minutes. Alternatively, the thermal processing may occur at a temperature of about 200° F. and for an amount of time from about 20 to about 25 minutes. Further, the thermal processing may occur at a temperature from about 200° F. to about 220° F. and for an amount of time from about 10 to about 25 minutes. Similarly, the thermal processing may occur at a temperature of about 210° F. and for an amount of time from about 15 to about 20 minutes, or at a temperature from about 210° F. to about 230° F. and for an amount of time from about 5 to about 20 minutes, or at a temperature of about 220° F. and for an amount of time from about 10 to about 15 minutes. The skilled artisan will appreciate, however, that the thermal processing parameters of the present disclosure are not limited by the examples and combinations set forth herein.

The tests showed that a yogurt/grain/fruit product prepared by Applicant and retorted at 200° F. for about 20-25 minutes maintained great color and the texture of the fruit and grain portion was much improved over the color and the texture of the fruit and grain portion of a yogurt product retorted at 250° F. Indeed, modifying the process not only improved the yogurt's color and flavor, but also the grain/fruit texture/particle integrity.

The concern with processing grains at a lower temperature than 250° F. is that the product may not be processed enough to inactivate the enzyme alpha-amylase. This enzyme breaks down starch, resulting in product thinning. However, Applicant has not observed product thinning in the initial studies described herein. Literature shows that some grains have an inherent alpha-amylase inhibitor. See, e.g., Weselake, et al., “Endogenous Alpha-Amylase Inhibitor in Various Cereals,” Cereal Chem., 62(2):120-123 (1985); and Robertson et al., “Accumulation of an Endogenous Alpha-amylase Inhibitor in Barley During Grain Development,” J. of Cereal Science, vol. 9, 237-246 (1989). In particular, barley contains an alpha-amylase inhibitor. Without being bound to any theory, Applicant believes that, since the yogurts tested by Applicant included both oats and barley, the alpha-amylase inhibitor in the barley may be inhibiting any amylase activity in the oats.

Accordingly, the present disclosure provides methods that can improve the color of thermally processed yogurts without the addition of other ingredients (e.g., preservatives). Additionally, Applicant has surprisingly discovered a way to improve the thermal process of any barley-containing product (as long as it is acidified) to improve particle integrity of the grain pieces and quality of the entire product. By “improved integrity” or “improving integrity,” it is meant that the integrity of the particles after thermal processing more closely resembled a natural integrity of the particles, or the integrity of the particles prior to thermal processing when compared to the same or similar particles in a dairy-based composition exposed to typical thermal processing at temperatures above, for example, 240° F. or 250° F.

The present dairy-based compositions may also include other beneficial or functional ingredients. For example, the dairy-based compositions may include a source of protein. The protein source may be dietary protein including, but not limited to animal protein (such as meat protein or egg protein), dairy protein (such as casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate)), vegetable protein (such as soy protein, wheat protein, rice protein, and pea protein), or combinations thereof. In an embodiment, the protein source is selected from the group consisting of whey, chicken, corn, caseinate, wheat, flax, soy, carob, pea, or combinations thereof.

In an embodiment, the dairy-based compositions further include one or more prebiotics. The prebiotics may be selected from the group consisting of acacia gum, alpha glucan, arabinogalactans, beta glucan, dextrans, fructooligosaccharides, galactooligosaccharides, galactomannans, gentiooligosaccharides, glucooligosaccharides, guar gum, inulin, isomaltooligosaccharides, lactosucrose, lactulose, levan, maltodextrins, partially hydrolyzed guar gum, pecticoligosaccharides, retrograded starch, soyoligosaccharides, sugar alcohols, xylooligosaccharides, or combinations thereof.

In an embodiment, the dairy-based compositions further include one or more probiotics selected from the group consisting of Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The dairy-based compositions may also include a source of fiber, fiber or a blend of different types of fiber. The fiber blend may contain a mixture of soluble and insoluble fibers. Soluble fibers may include, for example, fructooligosaccharides, acacia gum, inulin, etc. Insoluble fibers may include, for example, pea outer fiber.

In an embodiment, the dairy-based compositions further include a source of carbohydrates. Any suitable carbohydrate may be used in the present nutritional compositions including, but not limited to, sucrose, lactose, glucose, fructose, corn syrup solids, maltodextrin, modified starch, amylose starch, tapioca starch, corn starch, or combinations thereof.

In an embodiment, the dairy-based compositions further include a source of fat. The source of fat may include any suitable fat or fat mixture. For example, the fat may include, but is not limited to, vegetable fat (such as olive oil, corn oil, sunflower oil, rapeseed oil, hazelnut oil, soy oil, palm oil, coconut oil, canola oil, lecithins, and the like) and animal fats (such as milk fat).

In another embodiment, the dairy-based compositions further include one or more amino acids. Non-limiting examples of amino acids include isoleucine, alanine, leucine, asparagine, lysine, aspartate, methionine, cysteine, phenylalanine, glutamate, threonine, glutamine, tryptophan, glycine, valine, proline, serine, tyrosine, arginine, citrulline, histidine, or combinations thereof.

In an embodiment, the dairy-based compositions further include one or more synbiotics, phytonutrients and/or antioxidants. The antioxidants may be selected from the group consisting of carotenoids, coenzyme Q10 (“CoQ10”), flavonoids, glutathione, Goji (Wolfberry), hesperidin, Lactowolfberry, lignan, lutein, lycopene, polyphenols, selenium, vitamin A, vitamin B1, vitamin B6, vitamin B12, vitamin C, vitamin D, vitamin E, or combinations thereof.

In an embodiment, the dairy-based compositions further include one or more vitamins and minerals. Non-limiting examples of vitamins include Vitamins A, B-complex (such as B-1, B-2, B-6 and B-12), C, D, E and K, niacin and acid vitamins such as pantothenic acid and folic acid, biotin, or combinations thereof. Non-limiting examples of minerals include calcium, iron, zinc, magnesium, iodine, copper, phosphorus, manganese, potassium, chromium, molybdenum, selenium, nickel, tin, silicon, vanadium, boron, or combinations thereof.

Other optional ingredients can be added to make the dairy-based compositions sufficiently palatable. For example, the dairy-based compositions can optionally include conventional food additives, such as any of, acidulants, additional thickeners, buffers or agents for pH adjustment, chelating agents, colorants, emulsifiers, excipients, flavor agents, minerals, osmotic agents, pharmaceutically acceptable carriers, preservatives, stabilizers, sugars, sweeteners, texturizers, or combinations thereof. The optional ingredients can be added in any suitable amount.

By way of example and not limitation, the following examples are illustrative of various embodiments of the present disclosure. The formulations and processes below are provided for exemplification only, and they can be modified by the skilled artisan to the necessary extent, depending on the special features that are desired.

### Example 1

### Dairy Product Made with Milk Protein Concentrate (“MPC”) Resembles Yogurt and Lessens the Degree of Color Changes During Retorting

Applicant tested a shelf-stable dairy product having grain and fruit particulates. The testing was performed by consumers in a home use test followed by focus groups. The results indicated a great concept, however, consumers desired an uncolored white yogurt. As discussed above, however, it is difficult to provide a thermally processed shelf-stable yogurt product that does not brown over the course of the shelf-life after retorting.

Applicant hypothesized that since yogurt browning is known to occur due to Maillard reactions, reducing the substrates of the Maillard reaction, specifically the reducing sugar lactose, would mitigate the browning effects. To reduce the amount of reducing sugars (e.g., lactose) to limit the substrates available for Maillard browning, MPC reconstituted to protein concentrations of milk was used in place of milk to make a yogurt-like product with low lactose levels. The yogurt-like product was then retorted at 250° F. for 25 minutes.

A summary of the experiments performed and the results obtained are set forth below in Table 9. As shown in Table 1, a first experiment compared a 1.5% lactose formula with natural fermentation to achieve a desired pH of <4.2 with a milk-based formula with natural fermentation and containing milk and cultures. The lactose formula contained MPC, cream, lactose, water and cultures. The 1.5% lactose formula included both naturally occurring lactose (e.g., about 0.4%) and well as about 1.1% added lactose for a total of about 1.5% lactose. The MPC formula is set forth below at Table 1. For analysis, the MPC formula and the Milk formula were incubated at a temperature of 42° C. for about 9 hours and 40 minutes. During the experiment, time lapse measurements were taken of both the pH and titratable acidity (as lactic acid) for both the MPC formula and the Milk formula. The pH and titratable acidity measurements for the MPC formula and the Milk formula are set forth below at Tables 2 and 3, respectively. It was found that the 1.5% lactose formula likely contained too much residual lactose.

TABLE 1
MPC Formula

| Ingredient | w/w % | Quantity (g) |
|---|---|---|
| MPC, 85% protein | 4.85 | 48.5 |
| Cream, heavy whipping | 8 | 80 |
| Lactose | 1.1 | 11 |
| Water | 86.047 | 860.47 |
| Culture, freeze-dried | 0.003 | 0.03 |

TABLE 2
MPC Formula Analysis

| Time From | | Titratable |
|---|---|---|
| Culturing (hh:mm) | pH | Acidity (%) |
| 0 | 6.618 | 0.091 |
| 01:50 | 6.326 | 0.103 |
| 04:20 | 4.781 | 0.4 |
| 05:20 | 4.55 | 0.581 |
| 06:10 | 4.41 | 0.577 |
| 24:00 | 4.391 | 0.629 |

TABLE 3
Milk Formula Analysis

| Time From | | Titratable |
|---|---|---|
| Culturing (hh:mm) | pH | Acidity (%) |
| 0 | 6.559 | 0.128 |
| 01:50 | 6.439 | 0.146 |
| 04:20 | 4.809 | 0.606 |
| 05:20 | 4.5 | 0.735 |
| 06:10 | 4.34 | 0.79 |
| 24:00 | 4.411 | 0.808 |

A second experiment analyzed a lower lactose formula with natural fermentation and additional lactic acid to achieve a desired pH of <4.2. The lower lactose formula included MPC, water and culture and naturally occurring lactose (e.g., about 0.4% lactose), no additional lactose was added. The MPC formula is set forth below at Table 4. To ensure a pH at or below about 4.2, Applicant used three different methods: (i) the culture was able to ferment the lactose to achieve the desired pH; or (ii) the culture somewhat fermented the lactose, but additional lactic acid was added (about 5 g lactic acid) to achieve the desired pH; or (iii) no culture was added, just lactic acid (about 5 g lactic acid) to achieve the desired pH. For the analysis, the MPC formula was incubated at a temperature of 40° C. for about 10 hours and 5 minutes. During the experiment, time lapse measurements were taken of both the pH and titratable acidity (as lactic acid) for the MPC formula, which are set forth below at Table 5. It was found that the use of MPC slowed the browning of the product, but did not inhibit browning. Applicant also hypothesized that the yogurt-like product may have browned due to the sugar or pectin in the formula.

TABLE 4
MPC Formula

| Ingredient | w/w % | Quantity (g) |
|---|---|---|
| MPC, 85% protein | 4.85 | 48.5 |
| Cream, heavy whipping | 0 | 0 |
| Lactose | 0 | 0 |
| Water | 95.147 | 951.47 |
| Culture, freeze-dried | 0.003 | 0.03 |

TABLE 5
MPC Formula Analysis

| Time From | | Titratable |
|---|---|---|
| Culturing (hh:mm) | pH | Acidity (%) |
| 0 | 0 | 0.025 |
| 02:00 | 6.621 | 0.030 |
| 03:00 | 6.331 | 0.056 |
| 04:00 | 5.971 | 0.084 |
| 05:00 | 5.990 | 0.086 |
| 06:00 | 5.956 | 0.088 |
| 07:00 | 5.988 | 0.087 |

A third experiment analyzed a lower lactose formula with natural fermentation and containing MPC, cream, water, culture, and additional lactic acid to achieve a desired pH<4.2. The MPC formula is set forth below at Table 6. Different variations of this formula were also investigated, namely: (i) with pectin; (ii) with pectin and sugar; (iii) without pectin; and (iv) without pectin and sugar, as set forth in Table 7 below. For the analysis, the MPC formula was incubated at a temperature of 42° C. for about 9 hours and 50 minutes. During the experiment, time lapse measurements were taken of both the pH and titratable acidity (as lactic acid) for the MPC formula, which are set forth below at Table 8. It was found that there was no significant difference in color with the omission of pectin, but that when sugar was added and yogurt was in contact with the film, browning occurred.

TABLE 6
MPC Formula

| Ingredient | w/w % | Quantity (g) |
|---|---|---|
| MPC, 85% protein | 4.85 | 145.5 |
| Cream, heavy whipping | 8 | 240 |
| Lactose | 0 | 0 |
| Water | 87.147 | 2614.41 |
| Culture, freeze-dried | 0.003 | 0.09 |

TABLE 7
MPC Formula Variations

| | Variable #1 | | Variable #2 | | Variable #3 | | Variable #4 | |
|---|---|---|---|---|---|---|---|---|
| | w/w | Quantity | w/w | Quantity | w/w | Quantity | w/w | Quantity |
| Ingredient | % | (g) | % | (g) | % | (g) | % | (g) |
| Pectin | 0 | 0 | 0 | 0 | 1 | 5 | 1 | 5 |
| Sugar | 0 | 0 | 8.35 | 41.75 | 0 | 0 | 8.35 | 41.75 |
| Yogurt Base | 96 | 480 | 87.65 | 438.3 | 95 | 475 | 86.65 | 433.25 |
| (MPC Formula) | | | | | | | | |
| Starch | 4 | 20 | 4 | 20 | 4 | 20 | 4 | 20 |

TABLE 8
MPC Formula Analysis

| Time From | | Titratable |
|---|---|---|
| Culturing (hh:mm) | pH | Acidity (%) |
| 00:25 | 7.019 | 0.033 |
| 03:50 | 5.713 | 0.155 |
| 05:00 | 5.344 | 0.232 |
| 06:00 | 5.324 | 0.248 |
| 07:00 | 5.318 | 0.25 |

As can be seen by the Summary of the experiments below in Table 9, although the dairy product made with MPC resembles yogurt and lessens the degree of color changes during retorting, some color was observed at 24 hours and 7 days post retort. Therefore, although modifying the formula is capable of slowing the browning process, browning was not completely mitigated over the course of time. Since more browning was observed in those prototypes containing sugar (e.g., a non-reducing sugar), Applicant hypothesized that browning may be due to the carmelization of sugar due to thermal processing.

TABLE 9
Summary of experiments

| | White base | Formula in | | |
|---|---|---|---|---|
| Experiments | formula | tray | Results | Comments |
| 1.5% lactose | 1.5% lactose | white base, | No significant | The 1.5% |
| formula with | formula | sugar, | difference in | lactose |
| natural | contained | pectin, | color post | formula |
| fermentation | MPC85, cream, | starch | retort | likely to |
| vs. milk based | lactose, water, | | | have too |
| formula with | culture; Milk | | | much |
| natural | formula | | | residual |
| fermentation | contained milk | | | lactose. |
| | and culture | | | |
| Lower lactose | MPC85,, | white base, | 24 hour and 7 | Browning |
| formula with | water, culture | sugar, | day post retort | slowed in |
| natural | | pectin, | prototype was | prototype |
| fermentation | | starch | whiter than | but not |
| and additional | | | control (milk). | inhibited. |
| lactic acid to | | | However, | Yogurt |
| achieve | | | weeks later | may also |
| desired pH | | | prototype | be |
| | | | exhibited | browning |
| | | | browning | due to |
| | | | | sugar or |
| | | | | pectin |
| Lower lactose | MPC85, | white base, | No significant | Browning |
| formula with | cream, | starch, | difference in | of product |
| natural | water, culture | pectin and | color with the | containing |
| fermentation | | sugar per | omission of | sugar was |
| and additional | | experi- | pectin. When | attributed |
| lactic acid to | | mental | sugar added | to |
| achieve | | design | and yogurt | localized |
| desired pH. 4 | | | was in contact | areas of |
| prototypes | | | with the film, | higher |
| were | | | browning | heat. |
| developed | | | occurred. | |
| from this | | | | |
| formula - with | | | | |
| pectin, with | | | | |
| pectin and | | | | |
| sugar, without | | | | |
| pectin, without | | | | |
| pectin and | | | | |
| sugar | | | | |

### Example 2

### Optimization of Thermal Process to Yield an Improvement in Color During the Retort Process

As mentioned above, Applicant performed tests of shelf-stable dairy-based compositions having grain and fruit particulates. The testing was performed by consumers in a home use test followed by focus groups. The results indicated a great concept, however, consumers wanted an uncolored white yogurt. A study was conducted to reduce browning attributed to Maillard browning and utilized MPC to reduce the amounts of reducing sugars (e.g., lactose) available for consumption by Maillard reactions. Unfortunately, using MPC in place of milk results in a yogurt-like product that cannot actually be called “yogurt.” In addition, although the browning was slowed, it was not eliminated. Therefore, Applicant also performed tests to optimize the retort process to inhibit browning.

In the tests to optimize the retort process to inhibit browning, Applicant hypothesized that yogurt browning occurs due to the carmelization of sugars, and that reducing the temperature of the thermal process will reduce carmelization and subsequently reduce the amount of browning observed in the yogurt. To test the hypothesis, Applicant prepared a yogurt made with low fat yogurt, pectin, sugar and starch with a pH of <4.2. Several batches of the same yogurt composition were retorted at different times and temperatures and the product was monitored over time for browning.

Retort times and temperatures of processed yogurt are set forth below in Table 10.

TABLE 10

| Time | Temp ° F. | | | CUT |
|---|---|---|---|---|
| (min) | 200 | 210 | 220 | (min) |
| 10 | | | X | 10 |
| 15 | | X | X | 10 |
| 20 | X | X | | 10 |
| 25 | X | | | 10 |

Applicant found that yogurt processed using the lowest temperature resulted in the whitest yogurt post retort. During the course of six months after the retort no browning was observed at 200° F. However, some browning began to occur in the yogurt processed at 220° F. after about six months.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for reducing or inhibiting browning of a thermally processed, shelf-stable dairy-based composition, the method comprising:
providing a dairy-based composition comprising milk protein concentrate and a reduced amount of reducing sugars; and
thermally processing the dairy-based composition at a temperature that is less than about 240° F. and for an amount of time from about 5 to about 40 minutes.

2. The method according to claim 1, wherein thermally processed is aseptic processing.

3. The method according to claim 1, wherein thermally processed is retort processing.

4. The method according to claim 1, wherein the dairy-based composition is substantially free of reducing sugars.

5. The method according to claim 1, wherein the dairy-based composition comprises only a naturally occurring amount of reducing sugars.

6. The method according to claim 1, wherein the dairy-based composition comprises only a naturally occurring amount of lactose.

7. The method according to claim 1, wherein the dairy-based composition includes particulates.

8. The method according to claim 1, wherein the dairy-based composition includes particulates selected from the group consisting of fruit, fruit pieces, grains, nuts, and combinations thereof.

9. The method according to claim 8, wherein the grains are selected from the group consisting of amaranth, barley, buckwheat, corn, cornmeal, popcorn, millet, oats, oatmeal, quinoa, rice, rye, sorghum, teff, triticale, wheat, wild rice, and combinations thereof.

10. The method according to claim 8, wherein the grains comprise oats and barley.

11. The method according to claim 8, wherein the fruit is selected from the group consisting of apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, and combinations thereof.

12. The method according to claim 7, wherein particle integrity in the thermally processed dairy-based composition is improved.

13. The method according to claim 1, wherein the dairy-based composition comprises at least one ingredient selected from the group consisting of a low fat yogurt, pectin, sugar, starch, and combinations thereof.

14. The method according to claim 1, wherein the dairy-based composition comprises a pH at or below about 4.2.

15. The method according to claim 1, wherein the thermal processing occurs at a temperature from about 190° F. to about 240° F.

16. The method according to claim 1, wherein the thermal processing occurs at a temperature from about 190° F. to about 210° F. and for an amount of time from about 10 to about 40 minutes.

17. The method according to claim 1, wherein the thermal processing occurs at a temperature from about 200° F. to about 220° F. and for an amount of time from about 10 to about 25 minutes.

18. The method according to claim 1, wherein the thermal processing occurs at a temperature from about 210° F. to about 230° F. and for an amount of time from about 5 to about 20 minutes.

19. The method according to claim 1, wherein the dairy-based composition is a yogurt composition.

20. The method according to claim 1, wherein the dairy-based composition after thermal processing has good: color, flavor, texture, or combinations thereof.
